(19) United States
(12) Patent Application Publication
(10) Pub. No.: US 2026/0253415 A1
(43) Pub. Date: Aug. 27, 2026

(54) METHOD, APPARATUS, DEVICE, AND MEDIUM FOR PROCESSING VIDEO BASED ON CONTRASTIVE LEARNING

(71) Applicant: Lemon Inc., Grand Cayman (KY)

(72) Inventors: Song BAI, Singapore (SG); Junfeng WU, Beijing (CN); Qihao LIU, Beijing (CN); Yi JIANG, Beijing (CN); Bin LU, Los Angeles, CA (US)

(21) Appl. No.: 18/877,977

(22) PCT Filed: Jun. 14, 2023
(86) PCT No.: PCT/SG2023/050421

§ 371 Date: Dec. 20, 2024

(30) Foreign Application Priority Data
Jun. 22, 2022 (CN) 202210714416.4

(51) Int. Cl. G06V 20/40; G06V 10/77; G06V 10/771

(52) U.S. Cl. CPC G06V 20/41; G06V 10/771; G06V 10/7715; G06V 20/46

(57) ABSTRACT

There are provided methods, apparatuses, devices, and media for processing video based on contrastive learning. At least one first object and at least one second object are extracted from a first frame and a second frame in a training video in training data, respectively. For a first object in the at least one first object, at least one positive sample object and at least one negative sample object associated with the first object are selected from the at least one second object based on the training data. A contrastive model is generated based on the at least one positive sample object and the at least one negative sample object, the contrastive model describing an association relationship between an object in a frame in a video and a contrastive feature of the object. The contrastive feature distinguishes whether objects in respective frames represent the same object, thereby improving the accuracy.

This application claims priority to Chinese Patent Application No. 202210714416.4, filed on Jun. 22, 2022, entitled “METHOD, APPARATUS, DEVICE, AND MEDIUM FOR PROCESSING VIDEO BASED ON CONTRASTIVE LEARNING”.

### FIELD

Example implementations of the present disclosure generally relate to video processing, and more particularly to methods, apparatuses, devices, and media for processing video based on contrastive learning.

### BACKGROUND

With the development of machine learning techniques, machine learning technique has been widely used in various technical fields. In the field of video processing, technical solutions have been proposed based on machine learning techniques to identify and track objects in multiple frames in a video. For example, after analyzing all the to-be-processed video, the offline processing technique may more accurately identify and track the objects in each frame. However, this technique cannot process real-time generated video and has a large time delay. Online processing techniques may process real-time generated videos; however, the techniques cannot accurately identify and track objects in individual frames. At this time, processing video in a more efficient manner has become a difficult point and hot spot in the field of video processing.

### SUMMARY

In a first aspect of the present disclosure, a method for processing a video is provided. In the method, at least one first object and at least one second object are extracted from a first frame and a second frame in a training video in training data, respectively. For a first object in the at least one first object, at least one positive sample object and at least one negative sample object associated with the first object are selected from the at least one second object based on the training data, the training data indicating that the at least one positive sample object and the first object represent a same object, and the at least one negative sample object and the first object represent different objects. A contrastive model is generated based on the at least one positive sample object and the at least one negative sample object, the contrastive model describing an association relationship between an object in a frame in a video and a contrastive feature of the object, and the contrastive model enabling a similarity between the contrastive feature and a further contrastive feature of a further object in a further frame in the video to indicate whether the object and the further object represent a same object.

In a second aspect of the present disclosure, an apparatus for processing a video is provided. The apparatus comprises: an extracting module, configured for extracting at least one first object and at least one second object from a first frame and a second frame in a training video in training data, respectively; a selecting module, configured for selecting, for a first object in the at least one first object, at least one positive sample object and at least one negative sample object associated with the first object from the at least one second object based on the training data, the training data indicating that the at least one positive sample object and the first object represent a same object, and the at least one negative sample object and the first object represent different objects; and a generating module, configured for generating a contrastive model based on the at least one positive sample object and the at least one negative sample object, the contrastive model describing an association relationship between an object in a frame in a video and a contrastive feature of the object, and the contrastive model enabling a similarity between the contrastive feature and a further contrastive feature of a further object in a further frame in the video to indicate whether the object and the further object represent a same object.

In a third aspect of the present disclosure, an electronic device is provided. The electronic device comprises: at least one processing unit; and at least one memory coupled to the at least one processing unit and storing instructions for execution by the at least one processing unit, the instructions, when executed by the at least one processing unit, causing the electronic device to perform the method according to the first aspect of the present disclosure.

In a fourth aspect of the present disclosure, there is provided a computer-readable storage medium having stored thereon a computer program which, when executed by a processor, causes the processor to implement the method according to the first aspect of the present disclosure.

It should be understood that the content described in the content part of the present disclosure is not intended to limit the key features or important features of the implementations of the present disclosure, nor is it intended to limit the scope of the present disclosure. Other features of the present disclosure will become readily understood from the following description.

### BRIEF DESCRIPTION OF DRAWINGS

The above and other features, advantages, and aspects of the various implementations of the present disclosure will become more apparent from the following detailed description taken in conjunction with the accompanying drawings. In the drawings, the same or similar reference numbers refer to the same or similar elements, wherein:

FIG. 1 illustrates a block diagram of an example environment in which implementations of the present disclosure may be implemented;

FIG. 2 illustrates a block diagram of a process for processing a video according to some implementations of the present disclosure;

FIG. 3 illustrates a block diagram of selecting a pair of image frames from a training video according to some implementations of the present disclosure;

FIG. 4 illustrates a block diagram of a process of processing key frames in a training video according to some implementations of the present disclosure;

FIGS. 5A and 5B illustrate block diagrams of process of processing reference frames in a training video according to some implementations of the present disclosure;

FIG. 6 illustrates a block diagram of selecting a positive sample object and a negative sample object based on a match score according to some implementations of the present disclosure;

FIG. 7 illustrates a block diagram of identifying objects in different frames based on contrastive features according to some implementations of the present disclosure;

FIG. 8 illustrates a block diagram of contrastive features of an object based on attenuation in accordance with some implementations of the present disclosure;

FIG. 9 illustrates a block diagram of identifying object in a plurality of frames according to some implementations of the present disclosure;

FIG. 10 illustrates a flowchart of a method for processing a video according to some implementations of the present disclosure;

FIG. 11 illustrates a block diagram of an apparatus for processing a video according to some implementations of the present disclosure; and

FIG. 12 illustrates a block diagram of a device capable of implementing various implementations of the present disclosure.

### DETAILED DESCRIPTION

The implementations of the present disclosure will be described in more detail with reference to the accompanying drawings, in which some implementations of the present disclosure have been illustrated. However, it should be understood that the present disclosure can be implemented in various manners, and thus should not be construed to be limited to implementations disclosed herein. On the contrary, those implementations are provided for the thorough and complete understanding of the present disclosure. It should be understood that the drawings and implementations of the present disclosure are only used for illustration, rather than limiting the protection scope of the present disclosure.

As used herein, the term “comprise” and its variants are to be read as open terms that mean “include, but is not limited to.” The term “based on” is to be read as “based at least in part on.” The term “one implementation” or “the implementation” is to be read as “at least one implementation.” The term “some implementations” is to be read as “at least some implementations.” Other definitions, explicit and implicit, might be further included below. As used herein, the term “model” may represent associations between respective data. For example, the above association may be obtained based on various technical solutions that are currently known and/or to be developed in future.

It is to be understood that the data involved in this technical solution (including but not limited to the data itself, data acquisition or use) should comply with the requirements of corresponding laws and regulations and relevant provisions.

It is to be understood that, before applying the technical solutions disclosed in respective embodiments of the present disclosure, the user should be informed of the type, scope of use, and use scenario of the personal information involved in the present disclosure in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

### Example Environment

In the context of this disclosure, an example of an animal is taken as an object to describe how to identify and track an object in a video. In other application environments, the video may comprise other types of objects. For example, in a logistics management system, packages in a logistics transportation process may be identified and tracked; in a traffic monitoring environment, individual vehicles in a road environment may be identified and tracked, and so on.

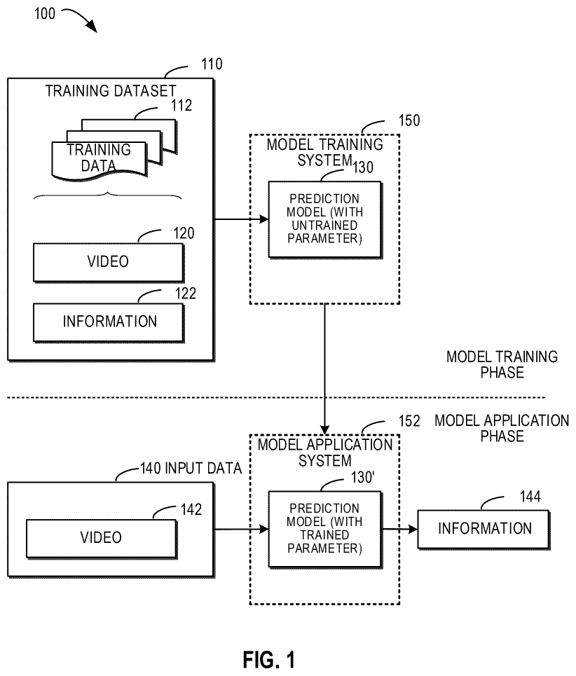

FIG. 1 illustrates a block diagram of an example environment 100 in which implementations of the present disclosure may be implemented. In the environment 100 of FIG. 1, it is desirable to train and use a video processing model (i.e., prediction model 130) configured to identify the same objects and different objects in individual frames in the video. Further, the model may determine a classification, a bounding box and a mask of an object, and so on. As shown in FIG. 1, environment 100 comprises a model training system 150 and a model application system 152. The upper part of FIG. 1 shows the process of the model training phase, and the lower part shows the process of the model application phase. Before training, the parameter value of the prediction model 130 may have an initial value, or may have a pre-trained parameter value through a pre-training process. The parameter values of the prediction model 130 may be updated and adjusted through the training process. The prediction model 130′ may be obtained after training is completed. At this time, the parameter value of the prediction model 130′ has been updated, and based on the updated parameter value, the prediction model 130′ may be used to implement the prediction task in the model application phase.

In the model training phase, the prediction model 130 may be trained by the model training system 150 based on the training dataset 110 comprising the plurality of training data 112. Here, each training data 112 may relate to a two-tuples format and comprise video 120 and information 122 related to the object in the video. At this point, the prediction model 130 may be trained with the training data 112 comprising video 120 and information 122. Specifically, the training process may be iteratively performed using a large amount of training data. After the training is complete, the prediction model 130 may comprise knowledge about the identification of the same object in the video. In the model application phase, the model application system 152 may be used to call the prediction model 130′ (the prediction model 130′ at this time has trained parameter values). For example, input data 140 (comprising video 142 to be processed) may be received, and information 144 (e.g., tracking the same object, etc.) of objects in various frames in the video 142 may be output.

In FIG. 1, the model training system 150 and the model application system 152 may comprise any computing system having computing capabilities, such as various computing devices/systems, terminal devices, servers, and the like. The terminal device may relate to any type of mobile terminal, fixed terminal, or portable terminal, comprising a mobile phone, a desktop computer, a laptop computer, a notebook computer, a netbook computer, a tablet computer, a media computer, a multimedia tablet, or any combination thereof, comprising accessories and peripherals of these devices, or any combination thereof. The servers comprise, but are not limited to, mainframes, edge computing nodes, computing devices in a cloud environment, and the like.

It should be understood that the components and arrangements in the environment 100 shown in FIG. 1 are merely examples, and that the computing system suitable for implementing the example implementations described in this disclosure may comprise one or more different components, other components, and/or different arrangements. For example, although shown as being separated, the model training system 150 and the model application system 152 may be integrated in the same system or device. Implementations of the present disclosure are not limited in this respect. Still referring to the accompanying drawings, example implementations of model training and model application are described below.

At present, a video processing technical solution has been proposed based on machine learning. Specifically, after analyzing the whole video that is to be processed, the offline processing technique may identify and track the objects in each frame. However, the real-time performance of the technique is poor and cannot process the video that is shot in real time. Online processing techniques may process real-time generated video; however, the response time and accuracy of the techniques are not satisfactory. Some online models perform independent object detection on each frame, so the processing quality of each frame is not stable. In particular, in the case where the video relates to a complex motion mode and serious occlusion, error accumulation will occur, thereby reducing the performance of object identification. At this time, how to process the video in a more efficient manner becomes a difficult point and hot spot in the field of video processing.

### Architecture of Video Processing Model

Based on the machine learning technique, a corresponding feature of each object of each frame in the video may be extracted. However, distributions of these features in the feature space will greatly affect whether the same and different objects in each frame may be accurately identified. In order to solve the deficiencies in the foregoing technical solutions, an In Defense of OnLine video processing framework, which is implemented based on a contrastive learning technique, is provided according to an example implementation of the present disclosure. According to the technical solution, the contrastive model may be used for determining the contrastive feature of each object in each frame. In this way, the contrastive features of the same object and different object may be better learned, such that the contrastive features of the same object are as close as possible in the feature space, and the contrastive features of different object are far away from each other in the feature space. Thus, the same object and different objects in each frame may be better distinguished.

Specifically, the contrastive model may extract a contrastive feature of an object in each frame in the video, so as to further determine whether each object in each frame represents a same object. For example, in a video comprising a plurality of animals, it is assumed that both image frames in the video comprise two horses (one large horse and one small horse), and at this time, two contrastive features of the horse in the two image frames are relatively close (that is, the similarity is higher), thereby indicating that the two horses in the two frames are the same object. Meanwhile, the two contrastive features for the horses and horses in the two image frames are far apart, and thus the large horse and the small horse in the two frames are identified to be different objects.

The key idea of the IDOL framework is to ensure that the contrastive features of the same object have similarities between the frames in the contrastive feature space, and ensure that the contrastive features of different objects in the frames have differences. This is true even for objects that belong to the same category and are very similar in appearance (e.g., the large horse and the small horse). With example implementations of the present disclosure, a more discriminative and more consistency contrastive feature may be provided to ensure that the same and different objects may be identified with higher accuracy across multiple frames.

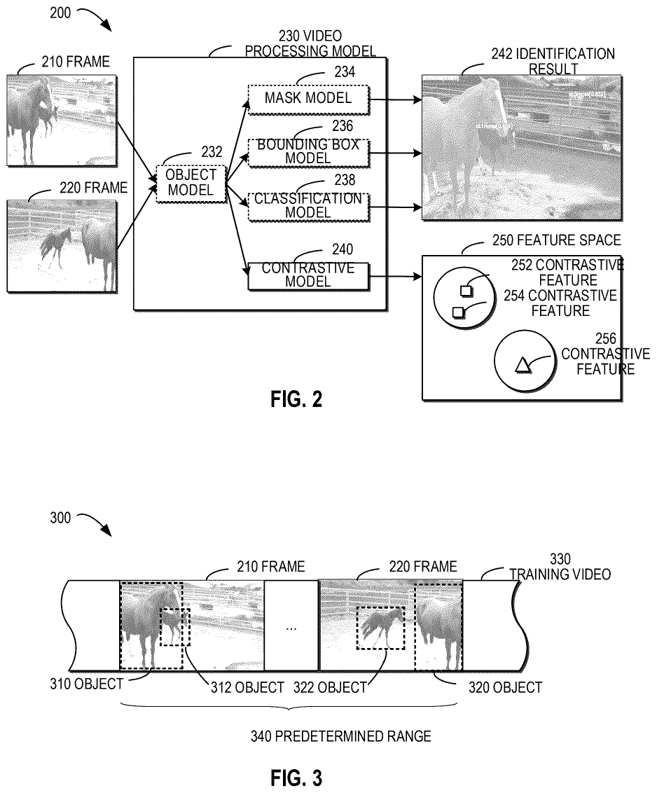

In the following, a summary of generating the contrastive model is first described with reference to FIG. 2. FIG. 2 shows a block diagram 200 of a process for processing a video according to some implementations of the present disclosure. As shown in FIG. 2, different frames, such as frame 210 and frame 220, may be extracted from the training video of the training data. For ease of description, the frame 210 may be referred to as a key frame (or a first frame), and the frame 220 may be referred to as a reference frame (or a second frame). In the context of the present disclosure, for ease of description, an object in the first frame may be referred to as a first object, and an object in the second frame may be referred to as a second object.

The video processing model 230 may be provided to process the video, and the video processing model 230 may comprise a plurality of sub-models: an object model 232, describing an association relationship between a frame and an object in the frame, and for extracting an object from each frame of the video; a mask model 234, describing an association relationship between an object in the frame and a mask of the object, and for determining a mask of the extracted object (for example, the mask may comprise a pixel region where the object is located); a bounding box model 236, describing an association relationship between the object in the frame and the bounding box of the object, and for determining a bounding box of the extracted object (for example, the bounding box may be represented by a rectangle); a classification model 238, describing an association relationship between the object in the frame and the classification of the object, and for determining the classification of the extracted object. For example, the classification may represent types and numbers, e.g., ID: horse 01, cow 02, and the like.

In the context of the present disclosure, the object model 232, the mask model 234, the bounding box model 236, and the classification model 238 may be implemented based on various models currently known and/or to be developed in the future. The determined mask, bounding box, and classification may be displayed in the identification result 242.

According to an example implementation of the present disclosure, the video processing model 230 may further comprise a contrastive model 240, configured to determine a contrastive feature of the extracted object. Here, the contrastive model 240 may output a corresponding contrastive feature for each object in each frame (e.g., an object extracted by the object model 232). For example, in the feature space 250 of the contrastive feature, the contrastive feature 252 may be output for the horse in the frame 210, and the feature 254 may be output for the horse in the frame 220, and the contrastive features 256 may be output for the horses in the frame 220.

As shown in FIG. 2, the contrastive features 252 and 254 are located in close regions in the feature space 250 and the distance between the two features is small. A smaller distance represents a larger similarity and may indicate that the large horse in frame 210 and the large horse in frame 220 represent the same object. The two contrastive features 252 and 256 are located in different regions in the feature space 250 and the distance between the two features is large. Here, a larger distance represents a smaller similarity and may indicate that the horse in frame 210 and the horse in frame 220 represent different objects.

With example implementations of the present disclosure, the contrastive model 240 may extract a corresponding contrastive feature for each object in each frame. In this case, the contrastive feature may distinguish whether the objects in respective frames are the same object, thereby improving accuracy of performing object identification and tracking across the frames. Further, the contrastive model 240 may be generated based on the training data, and once the contrastive model 240 has been generated, the contrastive model 240 may process the continuously collect image frames in real time, thereby providing the online object identification and tracking capability.

### Model Training Process

In the following, the process of training the video processing model 230 is first described. According to an example implementation of the present disclosure, the training data may comprise video and related data of each object in each frame in the video. For example, for a pair of frames 210 and 220 in the training video, the training data may indicate that the large horses in frames 210 and 220 represent the same object, the small horses in frames 210 and 220 represent the same object, and the other object in frames 210 and 220 represent different object. Alternatively and/or in addition, the training data may also comprise other feature data such as masks, bounding boxes, classifications and the like of the object.

According to an example implementation of the present disclosure, a pair of frames may be first extracted from the training video for performing a training process. FIG. 3 illustrates a block diagram 300 of selecting a pair of image frames from a training video according to some implementations of the present disclosure. As shown in FIG. 3, frames 210 and 220 may be extracted from a predetermined range 340 in the training video 330. It will be appreciated that the predetermined range 340, for example, may be set to a plurality of successive frames (e.g., 5 frames, 10 frames, or other values). In this way, it may be ensured that each frame within the predetermined range 340 comprises images of the same object, thereby ensuring that the contrastive model 240 is able to obtain knowledge about the same object in different frames. It will be appreciated that although FIG. 3 shows that the time of frame 210 is earlier than the time of frame 220, the timing relationship between frames 210 and 220 is not necessarily consequential. According to one example implementation of the present disclosure, the time of frame 210 may be later than the time of frame 220.

According to an example implementation of the present disclosure, at least one object may be extracted from frames 210 and 220, respectively. For example, objects 310 and 312 may be extracted from frame 210 using the object model 232, and objects 320 and 322 may be extracted from frame 220. It will be appreciated that the object model 232 may be implemented with various known object queriers and/or that will be developed in the future. Here, the parameter of the object model 232 may be set to an initialization value, or may be set to a pre-trained value. Further, a loss function may be constructed and the object model 232 may further be optimized using the difference between the ground true of the labeled object in the training data and predicted data, thereby improving the accuracy of the object model 232.

After the training is completed, the object model 232 may identify one or more object in the input image frame and represent the identified object with corresponding features. According to an example implementation of the present disclosure, an upper limit number of the identified object may be set, for example, it may specify that 300 objects may be identified. Assuming that only 3 objects are comprised in the input image frame, the first 3 features of the output result may indicate the identified 3 objects, and the other features may be set to null.

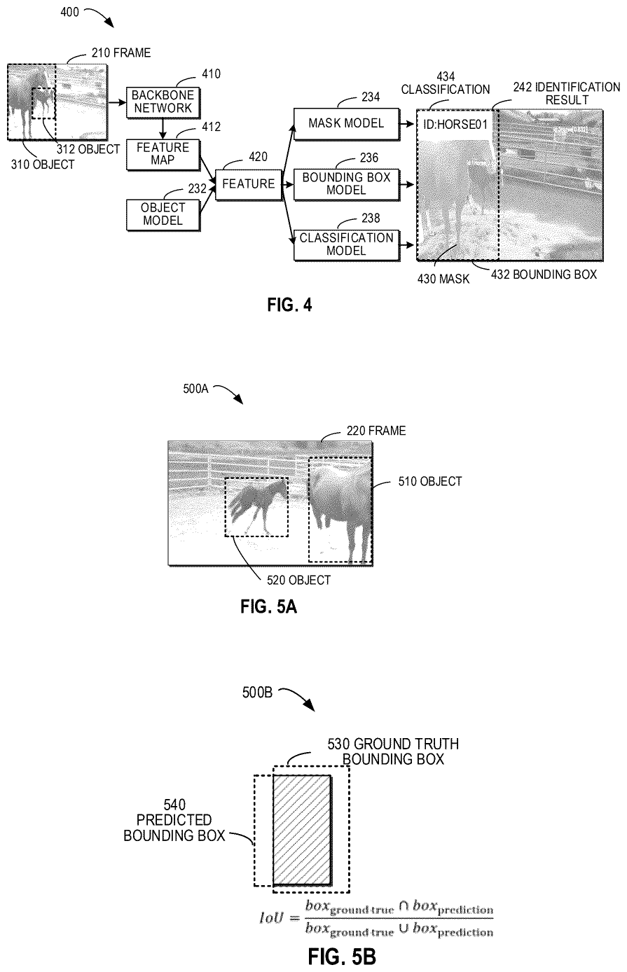

With reference to FIG. 4, more details are described below for processing the frame 210. FIG. 4 shows a block diagram 400 of a process of processing a key frame in a training video according to some implementations of the present disclosure. As shown in FIG. 4, the feature map 412 of the frame 210 may be extracted with the backbone network 410, e.g., based on a deformable detection transformer (DETR) network or another network structure, the feature 420 of each object comprised in the frame 210 may be extracted with the object model 232, the mask 430 of the object 310 may be determined using the mask model 234, the bounding box 432 of the object 310 may be determined using the bounding box model 236, and the classification 434 of the object 310 may be determined using the classification model 238.

According to one example implementation of the present disclosure, the mask model 234, the bounding box model 236, and the classification model 238 may be implemented in various ways currently known and/or to be developed in the future. For example, the above model may be implemented using a three layer feed-forward network (FFN), respectively. Alternatively and/or in addition, a feature pyramid network (FPN) mask branch may be used to use the multi-scale feature map from the transformer encoder, and generate a feature map represented at, for example, ⅛^{th} of the input frame resolution. Further, a convolution operation may be performed for the feature map using another FFN model based on Formula 1 below to obtain a mask for the object.

$${m}_{i} = MaskHead ( {F}_{mask} , {ω}_{i} ) \qquad Formula 1$$

In Formula 1, mᵢ represents the mask for the object i in the frame 210, MaskHead( ) represents a convolution operation for determining the mask, Fₘₐₛₖ represents a feature map represented by ⅛^{th} of the input frame resolution, and ωᵢ represents a convolution parameter.

It will be appreciated that although FIG. 4 schematically illustrates the feature 420 of only one object 310 (e.g., the large horse), similar processing may also be performed for one or more other objects identified (e.g., object 312 representing the small horse). At this time, the mask model 234, the bounding box model 236, and the classification model 238 may output a related mask, a bounding box, and a classification of each object. Further, for an object identified from the frame 210, a corresponding object may be searched in the frame 220 so as to determine a pair of objects used as training samples. For example, a pair of objects may comprise the large horse in frame 210 and frame 220, and the pair of objects may be used as positive training samples. In another example, a pair of objects may comprise the large horse in frame 210 and the small horse in frame 220, and this pair of objects may serve as negative training samples.

In the context of the present disclosure, the training data comprises label information of whether respective objects in respective frames represent the same object, and thus the positive sample object and the negative sample object associated with the object 310 may be selected from the objects in the frame 220 based on the label information. It will be understood that a positive sample object here and a given object in the key frame represent the same object, and a negative sample object and a given object in the key frame represent different objects. In this way, the existing knowledge in the training data may be fully utilized and more sample data may be used for training, thereby improving the accuracy of the contrastive model.

According to an example implementation of the present disclosure, in order to ensure that the accurate positive sample object and negative sample object may be extracted, whether the frames 210 and 220 comprise the same object may be first determined based on the training data. Further, when it is determined that the frames 210 and 220 comprise the same object, the frames 210 and 220 may be selected for further extracting the training samples. If the frames 210 and 220 do not comprise the same object, the positive sample object cannot be extracted. Thus, only frames comprising the same object may be selected to perform subsequent processing. At this time, since the training data indicates that the two frames comprise the same object, it may be ensured that the positive sample object and the negative sample object may be extracted from the frame 220 in subsequent processing. Therefore, it may avoid the condition that the positive sample object cannot be extracted due to the fact that the two frames do not comprise the same object.

Referring to FIG. 5A and taking the object 310 in the frame 210 as an example, the following paragraph will describe the process of finding the positive sample object and the negative sample object associated with the object 310 in the frame 220. Further, similar processing may be performed for other objects in the frame 210. FIG. 5A shows a block diagram 500A of a process of processing a reference frame in a training video according to some implementations of the present disclosure. As shown in FIG. 5A, one or more positive sample objects and one or more negative sample objects associated with object 310 in key frame 210 may be found in reference frame 220. Specifically, objects 510 and 520 may be identified from frame 220 using the object model 232 described above. Further, a positive sample object and a negative sample object associated with the object 310 may be selected from the identified objects 510 and 520. It will be understood that the positive sample object (e.g., object 510) and the object 310 represent the same object, and the negative sample object (e.g., object 520) and the object 310 represent different objects.

According to an example implementation of the present disclosure, in order to solve the problem that an object is difficult to be identified in an occlusion and crowded scenario, the problem of selecting the positive and negative sample objects may be converted into an optimal transmission problem. Specifically, the matching score of each object in the frame 220 may be determined based on the optimal transmission strategy. Further, an object with a higher score may be selected as a positive sample object, and an object with a lower score may be selected as a negative sample object. A similar process may be performed for each object in the frame 220, to determine a matching score for each object. Hereinafter, the specific steps of determining the matching score will be described only by taking the object 510 as an example.

FIG. 5B shows a block diagram 500B of a process of processing a reference frame in a training video according to some implementations of the present disclosure. The bounding box model 236 may be utilized to determine the predicted bounding box 540 of the object 510. Further, a ground-truth bounding box 530 associated with the object 510 may be determined from the training data, and a matching score for the object 510 may be determined based on a comparison of the predicted bounding box 540 and the ground-truth bounding box 530.

Based on the optimal transmission strategy, it may be considered that if the overlap degree (Intersection over Union, abbreviated as IoU) of the predicted bounding box 540 and the ground true bounding box 530 of the object 510 is higher, the object 510 and the object 310 are more likely to represent the same object. With example implementations of the present disclosure, the positive sample object and the negative sample object may be selected with the support of the IoU of the two bounding boxes. In this way, the sample object may be extracted from the image frame in a more accurate way, thereby improving the accuracy of the contrastive model 240. As shown in FIG. 5B, the matching score may be determined based on the IoU of the two bounding boxes by using Formula 2:

$$IoU = \frac{{box}_{g r ound true} ∩ {box}_{prediction}}{{box}_{g r ound true} ⋃ {box}_{prediction}} \qquad Formula 2$$

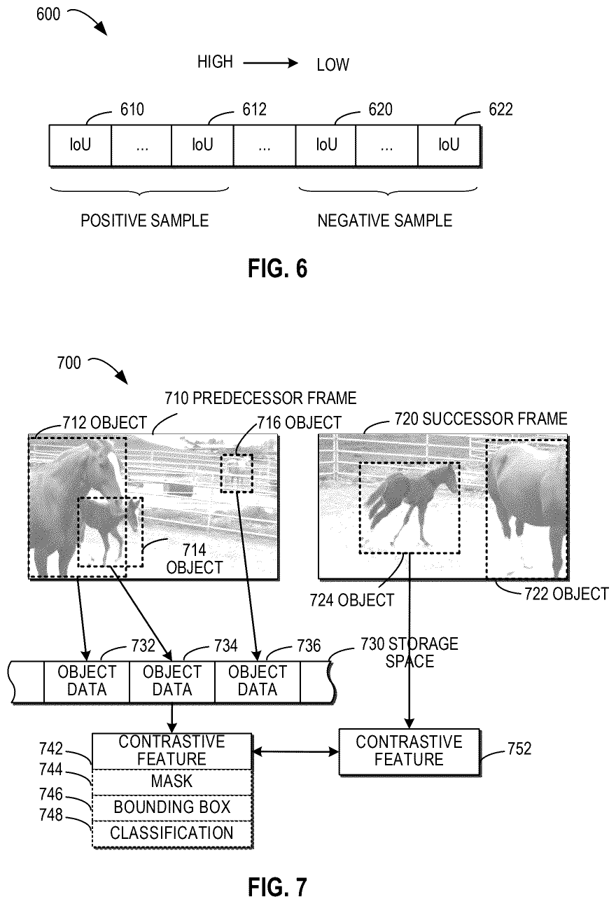

In Formula 2, IoU represents a matching score for the object 510, box_{ground true} represents a truth bounding box 530 for the object 510, and box_{prediction} represents a predicted bounding box for the object 510. In this way, the matching score of each object in the reference frame may be determined by simple mathematical operations. According to one example implementation of the present disclosure, each object detected from frame 220 may be processed in a similar manner and a corresponding IoU score may be determined. Further, the IoU scores of the determined objects may be sorted according to FIG. 6.

FIG. 6 illustrates a block diagram 600 of selecting a positive sample object and a negative sample object based on a matching score in accordance with some implementations of the present disclosure. As shown in FIG. 6, each object may be sorted according to the IoU score. One or more object with higher IoU scores may be selected as the positive sample objects, and one or more object with lower IoU scores may be selected as the negative sample objects. At this time, the matching score of the positive sample object is higher than the matching score of the negative sample object. In this way, more trusted training samples may be extracted from the training video, thereby improving the accuracy of the contrastive model 240.

According to an example implementation of the present disclosure, the number of positive sample objects and negative sample object may be pre-specified, and the numbers of positive sample objects and negative sample object may be the same or different. Alternatively and/or in addition, the number may be dynamically determined. For example, a positive threshold and a negative threshold may be specified, and one or more objects whose IoU scores are above the positive threshold may be selected as the positive sample objects, and one or more object whose IoU scores are lower than the negative threshold may be selected as negative sample objects.

According to an example implementation of the present disclosure, in the case where the positive sample object and the negative sample object have been determined, the contrastive model 240 may be generated by using these sample objects. The initial contrastive model may be trained based on various training approaches currently known and/or to be developed in the future. The trained contrastive model 240 may describe an association relationship between an object in a frame in the video and a contrastive feature of the object. That is, the contrastive model 240 may cause a similarity, which is between the contrastive feature and a further contrastive feature of a further object in a further frame in the video, to indicate whether the object and the further object represent the same object.

Assuming that m+ positive sample objects and m− negative sample objects have been determined, the contrastive model 240 may be iteratively trained using the sample objects and related information of the object 310 in the key frame. Specifically, an object (e.g., object 310) with the highest IoU score in the frame 210 may be input into the contrastive model 240 to determine a corresponding contrastive feature. Further, the m+ positive sample objects and the m− negative sample objects may be respectively input into the contrastive model 240 to determine the corresponding positive sample features and the negative sample features. Further, the loss function may be determined based on Formula 3 below.

$$\begin{matrix}{ℒ}_{embed} = - log \frac{exp ( v \cdot {k}^{+} )}{exp ( v \cdot {k}^{+} ) + {\sum }_{{k}^{-}} exp ( v \cdot {k}^{-} )} \\ = log [ 1 + {\sum }_{{k}^{-}} exp ( v \cdot {k}^{-} - v \cdot {k}^{+} ) ] ,\end{matrix} \qquad Formula 3$$

In Formula 3, [symbol] _{embed} represents a loss function of the contrastive model 240, v represents a contrastive feature of the object 310, k+ represents positive sample features of the m+ selected positive sample objects, and k− represents negative sample features of the m− selected negative sample objects, log( ) represents a logarithmic operation and exp( ) represents an exponential operation. According to an example implementation of the present disclosure, Formula 3 may be extended to Formula 4.

$${ℒ}_{embed} = log [ 1 + {\sum }_{{k}^{+}} {\sum }_{{k}^{-}} exp ( v \cdot {k}^{-} - v \cdot {k}^{+} ) ] \qquad Formula 4$$

In Formula 4, the meaning of each symbol is the same as that shown in the foregoing formula, and details are not described herein again. At this point, the contrastive model 240 may be trained based on the loss function formula and toward a direction that minimizes the loss function. It will be understood that since the positive sample objects and the negative sample objects may respectively represent objects that are the same as the object 310 in the frame 210 and objects that are different from the object 310 in the frame 210, the training may be performed by using the related label data of the sample object, so that the contrastive model 240 obtains various knowledges about the same object and different objects, thereby improving the accuracy of the contrastive model 240.

According to an example implementation of the present disclosure, in the process of determining the loss function, other feature data of the object may also be considered. Here, the feature data comprises at least one of: a classification, a bounding box, and a mask of the object. In this case, the loss function may be represented by using any of the following formulas:

$$ℒ = sum ( {ℒ}_{cls} , {λ}_{1} {ℒ}_{box} , {λ}_{1} {ℒ}_{mask} ) + {λ}_{2} {ℒ}_{embed} \qquad Formula 5$$

In Formula 5, [symbol] represents a loss function of the contrastive model 240, [symbol] _{cls} represents a loss function associated with the classification, [symbol] _{box} represents a loss function associated with the bounding box, [symbol] ₘₐₛₖ represents a loss function associated with the mask, [symbol] _{embed} represents a loss function associated with the contrastive feature determined based on the above Formula 4, sum( ) represents a summation of one or more data items in the parentheses, λ₁ and λ₂ represent predefined weights, respectively. According to an example implementation of the present disclosure, the contrastive model 240 may be trained in a direction that minimizes a loss function shown in Formula 5. With example implementations of the present disclosure, masks, bounding boxes, and classification of objects may be further considered during training of the contrastive model 240. In this way, various factors that affect the object identification may be fully considered, thereby improving the accuracy of the contrastive model 240.

With example implementations of the present disclosure, a large number of key frames and reference frames may be extracted from one or more training videos, and sample objects may be selected from these key frames and reference frame for performing the training. Using these sample objects to train the contrastive model 240 may enable the contrastive model 240 to determine contrastive features for individual objects in each frame. In this way, the related knowledge of the same object and different objects may be better learned, such that the contrastive features of the same object are as close as possible in the feature space, and the contrastive features of different objects are far away from each other in the feature space. Thus, the contrastive model 240 and the contrastive features may be further used to identify the same object and different objects in each frame.

### Model Application Process

The training process of each model in the video processing model 230 has been described above, and the following paragraph will describe how to use the video processing model 230 to identify each object in each frame in the video. According to an example implementation of the present disclosure, the to-be-processed target video may be input to the video processing model 230, and at this time, the video processing model 230 may output related information of each object in each frame, for example, whether each object represents a same object, and optionally, a mask of each object, a bounding box, and a classification, and the like.

FIG. 7 illustrates a block diagram 700 of identifying object in different frames based on contrastive features in accordance with some implementations of the present disclosure. The to-be-processed target video may be received, and each frame in the target video may be input to the video processing model 230 one by one in the chronological order. For ease of description, a frame with an earlier time in the target video may be referred to as a predecessor frame 710, and a later frame after the predecessor frame 710 may be referred to as a successor frame 720. In FIG. 7, the video processing model 230 first processes the predecessor frames 710 in the target video.

Specifically, the object model 232 in the video processing model 230 may extract a plurality of objects 712, 714, and 716 from the predecessor frame 710, and may respectively determine the contrastive features of these objects by using the contrastive model 240. Alternatively and/or in addition, the mask model 234, the bounding box model 236, the classification model 238 may be utilized to determine the mask, the bounding box, and the classification associated with the individual object, respectively. It will be understood that the video processing model 230 herein is an accurate processing model that has been obtained based on the training data, so that the predicted contrastive features, masks, bounding boxes, and classifications may be accurately output by using the models in the video processing model 230.

Further, object data (comprising the contrastive features, alternatively and/or in addition, the masks, bounding boxes, classifications) associated with various objects 712, 714, and 716 may be stored in the storage space 730. In this case, the storage space 730 may comprise object data 732 corresponding to the object 712, object data 734 corresponding to the object 714, and object data 736 corresponding to the object 716. By way of example only, the object data 734 may comprise contrastive features 742 of object 714. Alternatively and/or in addition, the object data 734 may comprise richer content, such as the mask 744, the bounding box 746, and the classification 748.

At this time, the object data in the storage space 730 may be used as a contrastive basis for processing successor image frames. In other words, the contrastive feature of the object in the successor frame may be compared with the contrastive feature in the storage space 730, to determine whether two objects in the predecessor frame 710 and the successor frame 720 represent the same object. Still referring to FIG. 7, a successor frame 720 may be input to the video processing model 230. At this point, the object model 232 may extract the objects 722 and 724 from the successor frame 720, and so on. In the following, more details about the object identification will be described only with object 724 as an example.

According to an example implementation of the present disclosure, the contrastive model 240 may be used to determine the contrastive feature 752 of the object 724, and compare the contrastive feature 752 with each contrastive feature in the storage space 730, so as to determine the object, having the highest similarity with the object 724, in the predecessor frame 710. Further, the corresponding two objects may be managed based on the similarity between the contrastive features of the two objects.

According to an example implementation of the present disclosure, the similarity between the contrastive features 752 and 742 may be determined based on various manners. For example, the similarity may be determined based on the distance between the two contrastive features 752 and 742. It will be understood that the contrastive model 240 here is obtained based on two objects (positive samples) representing the same object and two objects (negative samples) representing different objects, so the distance between the two contrastive features output by the contrastive model 240 may reflect whether the two objects represent the same object. A smaller distance may indicate that the two objects represent the same object, and a larger distance may indicate that two objects represent different objects. In this way, by comparing the contrastive features of the two objects in different frames, it is possible to determine whether the two object represent the same object in a simple and accurate manner.

According to an example implementation of the present disclosure, in order to track an object more accurately across multiple frames, the object 724 may be compared with a contrastive feature of each object in the storage space 730, so as to find the most similar object. It is assumed that the successor frame 720 comprises N objects, and the contrastive feature of the object i (that is, the i^{th} object in the N objects) may be represented as dᵢ(0≤i≤N); assuming that the storage space 730 comprises M objects, the contrastive feature of the object j (that is, the j^{th} object in the M objects) may be represented as dⱼ(0≤j≤N). The similarity between the two contrastive features may be determined based on Formula 6 as follows:

$$f ( i , j ) = \frac{exp ( {\hat{e}}_{j} \cdot {d}_{i} )}{{\sum }_{k = 1}^{M} exp ( {\hat{e}}_{k} \cdot {d}_{i} )} \qquad Formula 6$$

In Formula 6, j represents an object in the storage space 730, i represents an object in the successor frame 720, exp( ) represents an exponent operation, êⱼ represents a contrastive feature of the object j in the storage space 730, and dᵢ represents a contrastive feature of the object i in the successor frame 720. In this case, the larger the value f(i, j) is, the more similar the two objects are.

According to an example implementation of the present disclosure, the existence time of the contrastive feature êⱼ in the storage space 730 may be further considered. Thus, Formula 6 may be deformed into Formula 7:

$$f ( i , j ) = \frac{exp ( {\hat{e}}_{j} \cdot {d}_{i} ) + {σ}_{j}}{{\sum }_{k = 1}^{M} exp ( {\hat{e}}_{k} \cdot {d}_{i} ) + {σ}_{k}} \qquad Formula 7$$

In Formula 7, σⱼ represents the time that the object j exists in the storage space 730, σₖ represents the time that the object k exists in the storage space 730, and the meaning of the other symbols is the same as that shown in the above formula, and details are not described herein again.

The above Formulas 6 and 7 show the case where the object i in the successor frame 720 is compared with each object in the storage space 730 to determine the similarity in one direction. According to an example implementation of the present disclosure, the object j in the storage space may be compared with each object in the successor frame 720, so as to determine the similarity in another direction. Further, the final similarity may be determined based on an average (or sum, and the like) of similarity in both directions. Specifically, the similarity of the contrastive features of the two objects may be determined based on the following Formula 8:

$$f ( i , j ) = ( \frac{exp ( {\hat{e}}_{j} \cdot {d}_{i} ) + {σ}_{j}}{{\sum }_{k = 1}^{M} exp ( {\hat{e}}_{k} \cdot {d}_{i} ) + {σ}_{k}} + \frac{exp ( {\hat{e}}_{j} \cdot {d}_{i} )}{{\sum }_{k = 1}^{N} exp ( {\hat{e}}_{j} \cdot {d}_{k} )} ) / 2 \qquad Formula 8$$

In Formula 8, the meaning of the symbol is the same as that shown in the foregoing formula, and details are not described herein again. Based on the definition of Formula 8, it may be seen that if the similarity satisfies a threshold condition (e.g., close to 0.5), it indicates that the two objects represent the same object. With example implementations of the present disclosure, a complex task of detecting whether two objects represent the same object may be converted into the mathematical operation shown in any one of Formulas 6 to 8. Specifically, object ĵ which is most similar to the object i in the successor frame 720 may be determined based on Formula 7:

$$\hat{J} = arg max f ( i , j ) , ∀ j ∈ \{ 1 , 2 , … , M \} \qquad Formula 9$$

In Formula 9, ĵ represents the object which is most similar to the object i in the successor frame 720, argmax represents that f(i, j) has the maximum value when j=ĵ. According to an example implementation of the present disclosure, if the maximum similarity satisfies the threshold condition, it may be determined that the object 714 in the predecessor frame 710 and the object 724 in the successor frame 720 represent the same object. In this case, the contrastive feature 752 may be used to update the contrastive feature 742 in the storage space 730. Specifically, the updated contrastive feature of the object 724 (i.e., the object 714) may be determined based on the distance between the predecessor frame 710 and the successor frame 720 and the contrastive features 752, and 742.

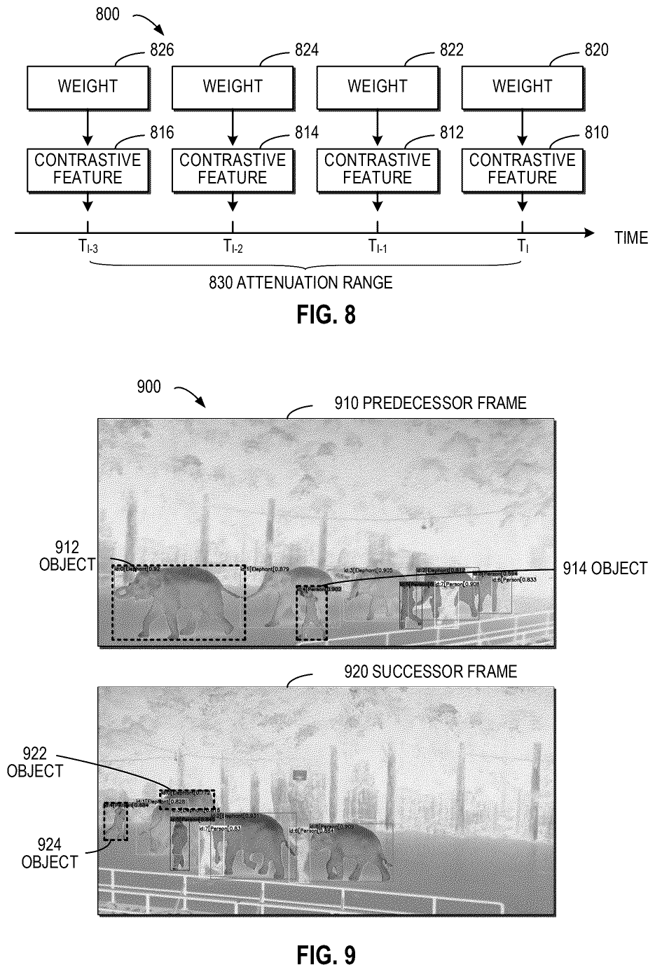

According to an example implementation of the present disclosure, since respective image frames in the video comprises continuous images of the object, the contrastive feature of the same object in the previous frame may be further considered when determining the contrastive feature of the object. Specifically, an attenuation range may be set and the contrastive feature of the object in the current frame may be determined by using the contrastive feature of the same object in other frames in the attenuation range where the current frame is located. FIG. 8 illustrates a block diagram 800 of contrastive features of an object based on attenuation, in accordance with some implementations of the present disclosure. As shown in FIG. 8, assuming that the current time is Tᵢ and the attenuation range 830 comprises 3 frames, the final contrastive feature of the object in the current frame may be determined based on the contrastive features of the same object in each frame in the attenuation range 830.

In FIG. 8, contrastive features 816, 814, 812, and 810 represent contrastive features of the object detected in the image frames at time points Tᵢ₋₃, Tᵢ₋₂, Tᵢ₋₁ and Tᵢ, respectively. In this case, the corresponding contrastive features 816, 814, 812 and 810 may be “attenuated” based on the attenuation coefficients 826, 824, 822, and 820 corresponding to the respective time points, thereby obtaining the final contrastive feature at the current time. According to an example implementation of the present disclosure, the weights 826, 824, 822, and 820 may be set to 0.1, 0.2, 0.3, 0.4 (or other values), respectively. It will be understood that the above weights merely illustrate examples of determining final contrastive features based on a plurality of contrastive features within the predetermined attenuation range 830. Alternatively and/or in addition, the final contrastive feature may be determined based on other formulas. For example, the final contrastive feature of the object j may be determined based on Formula 10:

$${\hat{e}}_{j} = \frac{{\sum }_{t = 1}^{T} {e}_{j}^{t} \times ( τ + T / t )}{{\sum }_{t = 1}^{T} ( τ + T / t )} \qquad Formula 10$$

In Formula 10, êⱼ represents the final contrastive feature of the object j in the storage space 730, T represents the width of the attenuation range, eⱼ^{t} represents the contrastive feature determined from each frame in the attenuation range, τ represents the first time point in the attenuation range. Generally, the similarity between objects in a closer image frame is higher. With example implementations of the present disclosure, the contrastive features in the storage space 730 may comprise information of objects within a plurality of continuous frames. In this way, rich features of objects that have appeared in previous frames may be recorded in a more comprehensive manner, thereby improving the accuracy of identifying the same object based on the similarity of the contrastive features.

By utilizing the example implementation of the present disclosure, a scenario with fast motion, occlusion, and crowded objects is fully considered, thereby reducing potential errors in object identification. Specifically, when the position and shape of the object are changed, the contrastive feature may comprise related knowledge of different positions and shapes at the previous time point. It supports that the priori information is used to identify object whose information is lost by occlusions or the like, so as to ensure the consistency and integrity of object identification. Thus, the contrastive features maintain a higher discrimination throughout the feature space. In this way, it may be more helpful to identify the same object and different objects in successor frames.

According to an example implementation of the present disclosure, if it is determined that the similarity between the contrastive features of the objects in the successor frame 720 and the contrastive feature in the storage region 730 is relatively low (for example, the threshold condition is not satisfied), it may be considered that the object in the successor frame 720 is a new object that has not appeared. At this point, the contrastive feature (alternatively and/or in addition, respective mask, bounding box, classification) may be added to the storage space 730. In this way, the contrastive feature of the identified object may be continuously updated, thereby improving the efficiency of the object identification in the successor image frame.

FIG. 9 illustrates a block diagram 900 of identifying object in a plurality of frames in accordance with some implementations of the present disclosure. The to-be-processed target video may be input to the video processing model 230. At this time, the video processing model 230 may identify the same object in each frame. For example, objects 912, 914, and the like may be identified from the predecessor frame 910, and objects 922, 924 may be identified from successor frames 920. At this point, based on the method described above, objects 912 and 922 represent the same object, and objects 914 and 924 represent the same object. Further, the video processing model 230 may output information such as masks, bounding boxes, and classifications associated with various objects. In this way, a motion trajectory for a given object may be tracked across multiple image frames.

According to an example implementation of the present disclosure, the above technical solutions may be implemented on different backbone networks. Further, the performance of the above-described technical solutions may be tested using a public dataset in the field of video processing (e.g., YouTube—VIS 2019, YouTube—VIS 2021, and OVIS datasets).

Table 1 below shows performance comparison using existing technical solutions and the IDOL technical solutions of the present disclosure over multiple backbone networks. Column 1 shows the backbone network on which each network model is based, column 2 shows the method used by the network model, column 3 shows the type of video processing (online video processing/offline video processing), column 4 shows the type of training data (V represents a video, I represents an image), and column 5-9 show the evaluation factor of average accuracy (the higher the numerical value is, the higher the precision). By comparison, the performance factor of the IDOL technical solution of the present disclosure is generally higher than that of the existing technical solutions, and higher identification accuracy may be achieved.

TABLE 1
Object Identification Performance Comparison

| Backbone | | | | | | | | |
|---|---|---|---|---|---|---|---|---|
| Network | Method | Type | Data | AP | AP₅₀ | AP₇₅ | AR₁ | AR₁₀ |
| ResNet-50 | MaskTrackR-CNN | Online | V | 30.3 | 51.1 | 32.6 | 31.0 | 35.5 |
| | SipMask | Online | V | 33.7 | 54.1 | 35.8 | 35.4 | 40.1 |
| | CompFeat | Online | V | 35.3 | 56.0 | 38.6 | 33.1 | 40.3 |
| | CrossVIS | Online | V | 36.3 | 56.8 | 38.9 | 35.6 | 40.7 |
| | PCAN | Online | V | 36.1 | 54.9 | 39.4 | 36.3 | 41.6 |
| | STEm-Seg | Offline | V + I | 30.6 | 50.7 | 33.5 | 37.6 | 37.1 |
| | VisTR | Offline | V | 36.2 | 59.8 | 36.9 | 37.2 | 42.4 |
| | MaskProp | Offline | V | 40.0 | — | 42.9 | — | — |
| | Propose-Reduce | Offline | V + I | 40.4 | 63.0 | 43.8 | 41.1 | 49.7 |
| | IFC | Offline | V | 42.8 | 65.8 | 46.8 | 43.8 | 51.2 |
| | SeqFormer | Offline | V | 45.1 | 66.9 | 50.5 | 45.6 | 54.6 |
| | IDOL (the disclosure) | Online | V | 46.4 | 70.7 | 51.9 | 44.8 | 54.9 |
| ResNet-101 | MaskTrackR-CNN | Online | V | 31.8 | 53.0 | 33.6 | 33.2 | 37.6 |
| | CrossVIS | Online | V | 36.6 | 57.3 | 39.7 | 36.0 | 42.0 |
| | PCAN | Online | V | 37.6 | 57.2 | 41.3 | 37.2 | 43.9 |
| | STEm-Seg | Offline | V + I | 34.6 | 55.8 | 37.9 | 34.4 | 41.6 |
| | VisTR | Offline | V | 40.1 | 64.0 | 45.0 | 38.3 | 44.9 |
| | MaskProp | Offline | V | 42.5 | — | 45.6 | — | — |
| | Propose-Reduce | Offline | V + I | 43.8 | 65.5 | 47.4 | 43.0 | 53.2 |
| | IFC | Offline | V | 44.6 | 69.2 | 49.5 | 44.0 | 52.1 |
| | SeqFormer | Offline | V + I | 49.0 | 71.1 | 55.7 | 46.8 | 56.9 |
| | IDOL(the disclosure) | Online | V | 48.2 | 73.6 | 52.5 | 45.6 | 55.5 |
| Swin-L | SeqFormer | Offline | V + I | 59.3 | 82.1 | 66.4 | 51.7 | 64.4 |
| | IDOL(the disclosure) | Online | V | 61.5 | 84.2 | 69.3 | 53.3 | 65.6 |

It may be seen from the data in Table 1 that a more accurate object identification capability may be provided by using the IDOL technical solution of the example implementation of the present disclosure. Especially in videos with complex occlusion and fast motion, the IDOL technical solution of the present disclosure has higher robustness and reliability.

### Example Processes

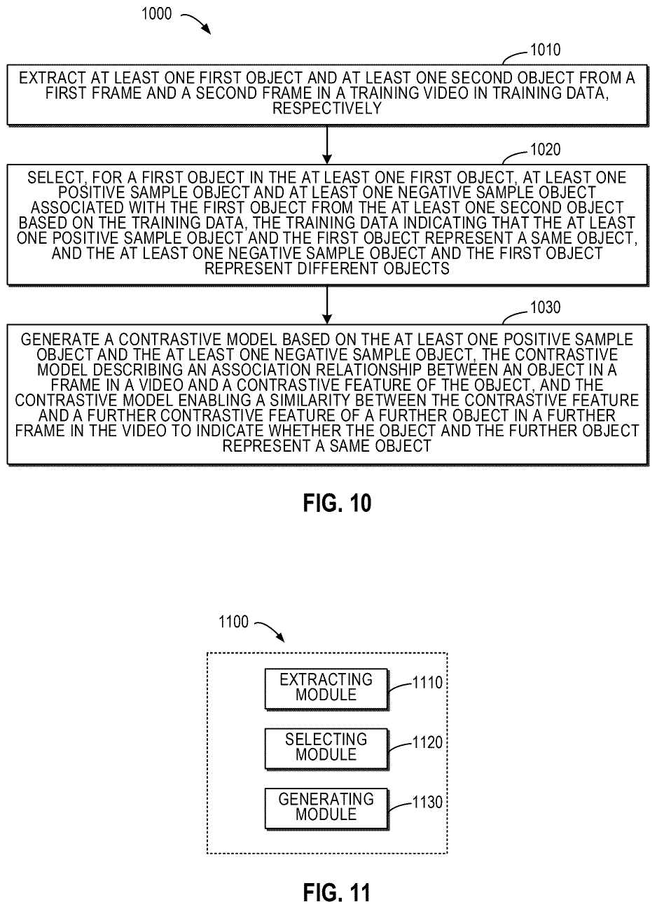

FIG. 10 shows a flowchart of a method 1000 for processing a video according to some implementations of the present disclosure. Specifically, at a block 1010, at least one first object and at least one second object are extracted from a first frame and a second frame in a training video in training data, respectively. At a block 1020, for a first object in the at least one first object, at least one positive sample object and at least one negative sample object associated with the first object are selected from the at least one second object based on the training data, the training data indicating that the at least one positive sample object and the first object represent a same object, and the at least one negative sample object and the first object represent different objects. At a block 1030, a contrastive model is generated based on the at least one positive sample object and the at least one negative sample object, the contrastive model describing an association relationship between an object in a frame in a video and a contrastive feature of the object, and the contrastive model enabling a similarity between the contrastive feature and a further contrastive feature of a further object in a further frame in the video to indicate whether the object and the further object represent a same object.

According to an example implementation of the present disclosure, selecting the at least one positive sample object and the at least one negative sample object comprises: determining, based on the training data, whether the first frame and the second frame comprise a same object; and in response to determining that the first frame and the second frame comprise the same object, selecting the at least one positive sample object and the at least one negative sample object.

According to an example implementation of the present disclosure, selecting the at least one positive sample object and the at least one negative sample object comprises: for a second object in the at least one second object, determining a predicted bounding box of the second object by using a bounding box model, the bounding box model describing an association relationship between an object in a frame in a video and a bounding box of the object; determining a matching score of the second object based on the predicted bounding box and a ground truth bounding box associated with the second object in the training data; and selecting the at least one positive sample object and the at least one negative sample object based on the matching score of the second object.

According to an example implementation of the present disclosure, selecting the at least one positive sample object and the at least one negative sample object based on the matching score of the second object comprises: sorting the at least one second object based on the matching score of the at least one second object; and selecting the at least one positive sample object and the at least one negative sample object from the sorted at least one second object, such that a matching score of the at least one positive sample object is higher than a matching score of the at least one negative sample object.

According to an example implementation of the present disclosure, generating the contrastive model comprises: determining, by using the contrastive model, a contrastive feature of the first object, at least one positive contrastive feature of the at least one positive sample object, and at least one negative contrastive feature of the at least one negative sample object, respectively; generating a loss function of the contrastive model based on the contrastive feature, the at least one positive contrastive feature, and the at least one negative contrastive feature; and training the contrastive model based on the loss function.

According to an example implementation of the present disclosure, the method further comprises: determining feature data associated with the first object, the feature data comprising at least one of: a classification, a bounding box, and a mask of the first object; and updating the loss function based on the feature data.

According to an example implementation of the present disclosure, the method further comprises: in response to receiving a target video to be processed, determining, by using the contrastive model, a predecessor contrastive feature of a predecessor object in a predecessor frame in the target video and a subsequent contrastive feature of a successor object in a successor frame in the target video, the successor frame is subsequent to the predecessor frame; determining a similarity between the predecessor contrastive feature and the successor contrastive feature; and managing the predecessor object and the successor object based on the similarity.

According to an example implementation of the present disclosure, determining the similarity between the predecessor contrastive feature and the successor contrastive feature comprises: determining a first similarity based on the predecessor contrastive feature and at least one contrastive feature of at least one object in the successor frame; determining a second similarity based on the successor contrastive feature and at least one contrastive feature of at least one object in the predecessor frame; and determining the similarity based on the first similarity and the second similarity.

According to an example implementation of the present disclosure, managing the predecessor object and the successor object based on the similarity comprises: in response to determining that the similarity satisfies a threshold condition, determining that the predecessor object and the successor object represent the same object; and determining an updated contrastive feature of the successor object based on a distance between the predecessor frame and the successor frame, the predecessor contrastive feature, and the successor contrastive feature.

According to an example implementation of the present disclosure, managing the predecessor object and the successor object based on the similarity comprises: in response to determining that the similarity does not satisfy a threshold condition, determining that the predecessor object and the successor object represent different objects; and storing the successor object and the successor contrastive feature.

### Example Apparatus and Device

FIG. 11 shows a block diagram of an apparatus 1100 for processing a video according to some implementations of the present disclosure. The apparatus 1100 comprises: an extracting module 1110, configured for extracting at least one first object and at least one second object from a first frame and a second frame in a training video in training data, respectively; a selecting module 1120, configured for selecting, for a first object in the at least one first object, at least one positive sample object and at least one negative sample object associated with the first object from the at least one second object based on the training data, the training data indicating that the at least one positive sample object and the first object represent a same object, and the at least one negative sample object and the first object represent different objects; and a generating module 1130, configured for generating a contrastive model based on the at least one positive sample object and the at least one negative sample object, the contrastive model describing an association relationship between an object in a frame in a video and a contrastive feature of the object, and the contrastive model enabling a similarity between the contrastive feature and a further contrastive feature of a further object in a further frame in the video to indicate whether the object and the further object represent a same object.

According to an example implementation of the present disclosure, the selecting module 1120 comprises: a determining module, configured for determining, based on the training data, whether the first frame and the second frame comprise a same object; and an object selecting module, configured for selecting the at least one positive sample object and the at least one negative sample object in response to determining that the first frame and the second frame comprise the same object.

According to an example implementation of the present disclosure, the object selecting module comprises: a bounding box determining module, configured for determining, for a second object in the at least one second object, a predicted bounding box of the second object by using a bounding box model, the bounding box model describing an association relationship between an object in a frame in a video and a bounding box of the object; a score determining module, configured for determining a matching score of the second object based on the predicted bounding box and a ground truth bounding box associated with the second object in the training data; and a sample object selecting module, configured for selecting the at least one positive sample object and the at least one negative sample object based on the matching score of the second object.

According to an example implementation of the present disclosure, the sample object selecting module comprises: a sorting module, configured for sorting the at least one second object based on the matching score of the at least one second object; and a positive-negative sample object selecting module, configured for selecting the at least one positive sample object and the at least one negative sample object from the sorted at least one second object, such that a matching score of the at least one positive sample object is higher than a matching score of the at least one negative sample object.

According to an example implementation of the present disclosure, the generating module 1130 comprises: a contrastive feature determining module, configured for determining, by using the contrastive model, a contrastive feature of the first object, at least one positive contrastive feature of the at least one positive sample object, and at least one negative contrastive feature of the at least one negative sample object, respectively; a loss determining module, configured for generating a loss function of the contrastive model based on the contrastive feature, the at least one positive contrastive feature, and the at least one negative contrastive feature; and a training module, configured for training the contrastive model based on the loss function.

According to an example implementation of the present disclosure, the apparatus 1100 further comprises: feature data determining module, configured for determining feature data associated with the first object, the feature data comprising at least one of: a classification, a bounding box, and a mask of the first object; and an updating module, configured for updating the loss function based on the feature data.

According to an example implementation of the present disclosure, the apparatus 1100 further comprises: a contrastive feature determining module, configured for determining, in response to receiving a target video to be processed and by using the contrastive model, a predecessor contrastive feature of a predecessor object in a predecessor frame in the target video and a subsequent contrastive feature of a successor object in a successor frame in the target video, the successor frame is subsequent to the predecessor frame; a similarity determining module, configured for determining a similarity between the predecessor contrastive feature and the successor contrastive feature; and a managing module, configured for managing the predecessor object and the successor object based on the similarity.

According to an example implementation of the present disclosure, the similarity determining module comprises: a first similarity determining module, configured for determining a first similarity based on the predecessor contrastive feature and at least one contrastive feature of at least one object in the successor frame; a second similarity determining module, configured for determining a second similarity based on the successor contrastive feature and at least one contrastive feature of at least one object in the predecessor frame; and a comprehensive similarity determining module, configured for determining the similarity based on the first similarity and the second similarity.

According to an example implementation of the present disclosure, the managing module comprises: a first managing module, configured for determining, in response to determining that the similarity satisfies a threshold condition, that the predecessor object and the successor object represent the same object; and a first updating module, configured for determining an updated contrastive feature of the successor object based on a distance between the predecessor frame and the successor frame, the predecessor contrastive feature, and the successor contrastive feature.

According to an example implementation of the present disclosure, the managing module comprises: a second managing module, configured for determining, in response to determining that the similarity does not satisfy a threshold condition, that the predecessor object and the successor object represent different objects; and a second updating module, configured for storing the successor object and the successor contrastive feature.

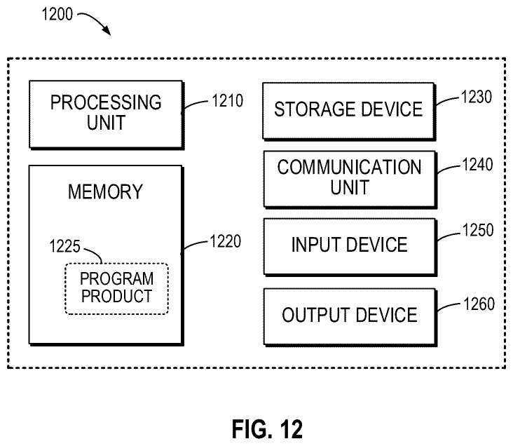

FIG. 12 illustrates a block diagram of a device 1200 that can implement a plurality of implementations of the present disclosure. It should be understood that the computing device 1200 shown in FIG. 12 is only exemplary and shall not constitute any limitation on the functions and scope of the implementations described herein. The computing device 1200 shown in FIG. 12 can be used to implement the method described above.

As shown in FIG. 12, the computing device 1200 is in the form of a general purpose computing device. Components of the computing device 1200 may include, but are not limited to, one or more processors or processing units 1210, a memory 1220, a storage device 1230, one or more communication units 1240, one or more input devices 1250, and one or more output devices 1260. The processing unit 1210 may be a physical or virtual processor and may execute various processing based on the programs stored in the memory 1220. In a multi-processor system, a plurality of processing units executes computer-executable instructions in parallel to enhance parallel processing capability of the computing device 1200.

The computing device 1200 usually includes a plurality of computer storage mediums. Such mediums may be any attainable medium accessible by the computing device 1200, including but not limited to, a volatile and non-volatile medium, a removable and non-removable medium. The memory 1220 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The storage device 1230 may be a removable or non-removable medium, and may include a machine-readable medium (e.g., a memory, a flash drive, a magnetic disk) or any other medium, which may be used for storing information and/or data (e.g., training data for training) and be accessed within the computing device 1200.

The computing device 1200 may further include additional removable/non-removable, volatile/non-volatile storage mediums. Although not shown in FIG. 10, there may be provided a disk drive for reading from or writing into a removable and non-volatile disk (e.g., “floppy disk”) and an optical disc drive for reading from or writing into a removable and non-volatile optical disc. In such cases, each drive may be connected to a bus (not shown) via one or more data medium interfaces. The memory 1220 may include a computer program product 1225 having one or more program modules, and these program modules are configured for performing various methods or acts of various implementations of the present disclosure.

The communication unit 1240 implements communication with another computing device via a communication medium. Additionally, functions of components of the computing device 1200 may be realized by a single computing cluster or a plurality of computing machines, and these computing machines may communicate through communication connections. Therefore, the computing device 1200 may operate in a networked environment using a logic connection to one or more other servers, a Personal Computer (PC) or a further general network node.

The input device 1250 may be one or more various input devices, such as a mouse, a keyboard, a trackball, a voice-input device, and the like. The output device 1260 may be one or more output devices, e.g., a display, a loudspeaker, a printer, and so on. The computing device 1200 may also communicate through the communication unit 1240 with one or more external devices (not shown) as required, where the external device, e.g., a storage device, a display device, and so on, communicates with one or more devices that enable users to interact with the computing device 1200, or with any device (such as a network card, a modem, and the like) that enable the computing device 1200 to communicate with one or more other computing devices. Such communication may be executed via an Input/Output (I/O) interface (not shown).

According to the example implementations of the present disclosure, a computer-readable storage medium is provided, on which computer-executable instructions are stored, wherein the computer-executable instructions are executed by a processor to implement the method described above. According to the example implementations of the present disclosure, a computer program product is further provided, which is tangibly stored on a non-transient computer-readable medium and includes computer-executable instructions, which are executed by a processor to implement the method described above. According to the example implementations of the present disclosure, a computer program product is provided, storing a computer program thereon, the program, when executed by a processor, implementing the method described above.

Aspects of the present disclosure are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to implementations disclosed. Many modifications and variations will be apparent to those of ordinary skill in the art without departing from the scope and spirit of the described implementations. The terminology used herein was chosen to best explain the principles of implementations, the practical application or technical improvement over technologies found in the marketplace, or to enable others of ordinary skill in the art to understand implementations disclosed herein.

1-20. (canceled)

21. A method for processing a video comprising:
extracting at least one first object and at least one second object from a first frame and a second frame in a training video in training data, respectively;
selecting, for a first object in the at least one first object, at least one positive sample object and at least one negative sample object associated with the first object from the at least one second object based on the training data, the training data indicating that the at least one positive sample object and the first object represent a same object, and the at least one negative sample object and the first object represent different objects; and
generating a contrastive model based on the at least one positive sample object and the at least one negative sample object, the contrastive model describing an association relationship between an object in a frame in a video and a contrastive feature of the object, and the contrastive model enabling a similarity between the contrastive feature and a further contrastive feature of a further object in a further frame in the video to indicate whether the object and the further object represent a same object.

22. The method of claim 21, wherein selecting the at least one positive sample object and the at least one negative sample object comprises:
determining, based on the training data, whether the first frame and the second frame comprise a same object; and
in response to determining that the first frame and the second frame comprise the same object, selecting the at least one positive sample object and the at least one negative sample object.

23. The method of claim 22, wherein selecting the at least one positive sample object and the at least one negative sample object comprises: for a second object in the at least one second object,
determining a predicted bounding box of the second object by using a bounding box model, the bounding box model describing an association relationship between an object in a frame in a video and a bounding box of the object;
determining a matching score of the second object based on the predicted bounding box and a ground truth bounding box associated with the second object in the training data; and
selecting the at least one positive sample object and the at least one negative sample object based on the matching score of the second object.

24. The method of claim 23, wherein selecting the at least one positive sample object and the at least one negative sample object based on the matching score of the second object comprises:
sorting the at least one second object based on the matching score of the at least one second object; and
selecting the at least one positive sample object and the at least one negative sample object from the sorted at least one second object, such that a matching score of the at least one positive sample object is higher than a matching score of the at least one negative sample object.

25. The method of claim 21, wherein generating the contrastive model comprises:
determining, by using the contrastive model, a contrastive feature of the first object, at least one positive contrastive feature of the at least one positive sample object, and at least one negative contrastive feature of the at least one negative sample object, respectively;
generating a loss function of the contrastive model based on the contrastive feature, the at least one positive contrastive feature, and the at least one negative contrastive feature; and
training the contrastive model based on the loss function.

26. The method of claim 25, further comprising:
determining feature data associated with the first object, the feature data comprising at least one of: a classification, a bounding box, and a mask of the first object; and
updating the loss function based on the feature data.

27. The method of claim 21, further comprising: in response to receiving a target video to be processed,
determining, by using the contrastive model, a predecessor contrastive feature of a predecessor object in a predecessor frame in the target video and a subsequent contrastive feature of a successor object in a successor frame in the target video, the successor frame is subsequent to the predecessor frame;
determining a similarity between the predecessor contrastive feature and the successor contrastive feature; and
managing the predecessor object and the successor object based on the similarity.

28. The method of claim 27, wherein determining the similarity between the predecessor contrastive feature and the successor contrastive feature comprises:
determining a first similarity based on the predecessor contrastive feature and at least one contrastive feature of at least one object in the successor frame;
determining a second similarity based on the successor contrastive feature and at least one contrastive feature of at least one object in the predecessor frame; and
determining the similarity based on the first similarity and the second similarity.

29. The method of claim 27, wherein managing the predecessor object and the successor object based on the similarity comprises:
in response to determining that the similarity satisfies a threshold condition, determining that the predecessor object and the successor object represent the same object; and
determining an updated contrastive feature of the successor object based on a distance between the predecessor frame and the successor frame, the predecessor contrastive feature, and the successor contrastive feature.

30. The method of claim 27, wherein managing the predecessor object and the successor object based on the similarity comprises:
in response to determining that the similarity does not satisfy a threshold condition, determining that the predecessor object and the successor object represent different objects; and
storing the successor object and the successor contrastive feature.

31. An electronic device comprising:
at least one processing unit; and
at least one memory coupled to the at least one processing unit and storing instructions executed by the at least one processing unit, the instructions, when executed by the at least one processing unit, causing the electronic device to perform a method for processing a video, the method comprising:
extracting at least one first object and at least one second object from a first frame and a second frame in a training video in training data, respectively;
selecting, for a first object in the at least one first object, at least one positive sample object and at least one negative sample object associated with the first object from the at least one second object based on the training data, the training data indicating that the at least one positive sample object and the first object represent a same object, and the at least one negative sample object and the first object represent different objects; and
generating a contrastive model based on the at least one positive sample object and the at least one negative sample object, the contrastive model describing an association relationship between an object in a frame in a video and a contrastive feature of the object, and the contrastive model enabling a similarity between the contrastive feature and a further contrastive feature of a further object in a further frame in the video to indicate whether the object and the further object represent a same object.

32. The device of claim 31, wherein selecting the at least one positive sample object and the at least one negative sample object comprises:
determining, based on the training data, whether the first frame and the second frame comprise a same object; and
in response to determining that the first frame and the second frame comprise the same object, selecting the at least one positive sample object and the at least one negative sample object.

33. The device of claim 32, wherein selecting the at least one positive sample object and the at least one negative sample object comprises: for a second object in the at least one second object,
determining a predicted bounding box of the second object by using a bounding box model, the bounding box model describing an association relationship between an object in a frame in a video and a bounding box of the object;
determining a matching score of the second object based on the predicted bounding box and a ground truth bounding box associated with the second object in the training data; and
selecting the at least one positive sample object and the at least one negative sample object based on the matching score of the second object.

34. The device of claim 33, wherein selecting the at least one positive sample object and the at least one negative sample object based on the matching score of the second object comprises:
sorting the at least one second object based on the matching score of the at least one second object; and
selecting the at least one positive sample object and the at least one negative sample object from the sorted at least one second object, such that a matching score of the at least one positive sample object is higher than a matching score of the at least one negative sample object.

35. The device of claim 31, wherein generating the contrastive model comprises:
determining, by using the contrastive model, a contrastive feature of the first object, at least one positive contrastive feature of the at least one positive sample object, and at least one negative contrastive feature of the at least one negative sample object, respectively;
generating a loss function of the contrastive model based on the contrastive feature, the at least one positive contrastive feature, and the at least one negative contrastive feature; and
training the contrastive model based on the loss function.

36. The device of claim 35, wherein the method further comprises:
determining feature data associated with the first object, the feature data comprising at least one of: a classification, a bounding box, and a mask of the first object; and
updating the loss function based on the feature data.

37. The device of claim 31, wherein the method further comprises: in response to receiving a target video to be processed,
determining, by using the contrastive model, a predecessor contrastive feature of a predecessor object in a predecessor frame in the target video and a subsequent contrastive feature of a successor object in a successor frame in the target video, the successor frame is subsequent to the predecessor frame;
determining a similarity between the predecessor contrastive feature and the successor contrastive feature; and
managing the predecessor object and the successor object based on the similarity.

38. The device of claim 37, wherein determining the similarity between the predecessor contrastive feature and the successor contrastive feature comprises:
determining a first similarity based on the predecessor contrastive feature and at least one contrastive feature of at least one object in the successor frame;
determining a second similarity based on the successor contrastive feature and at least one contrastive feature of at least one object in the predecessor frame; and
determining the similarity based on the first similarity and the second similarity.

39. The device of claim 37, wherein managing the predecessor object and the successor object based on the similarity comprises:
in response to determining that the similarity satisfies a threshold condition, determining that the predecessor object and the successor object represent the same object; and determining an updated contrastive feature of the successor object based on a distance between the predecessor frame and the successor frame, the predecessor contrastive feature, and the successor contrastive feature; or
in response to determining that the similarity does not satisfy a threshold condition, determining that the predecessor object and the successor object represent different objects; and
storing the successor object and the successor contrastive feature.

40. A non-transitory computer-readable storage medium, storing a computer program thereon, the computer program, when executed by a processor, causing the processor to implement a method for processing a video, the method comprising:
extracting at least one first object and at least one second object from a first frame and a second frame in a training video in training data, respectively;
selecting, for a first object in the at least one first object, at least one positive sample object and at least one negative sample object associated with the first object from the at least one second object based on the training data, the training data indicating that the at least one positive sample object and the first object represent a same object, and the at least one negative sample object and the first object represent different objects; and
generating a contrastive model based on the at least one positive sample object and the at least one negative sample object, the contrastive model describing an association relationship between an object in a frame in a video and a contrastive feature of the object, and the contrastive model enabling a similarity between the contrastive feature and a further contrastive feature of a further object in a further frame in the video to indicate whether the object and the further object represent a same object.
